(19) United States
(12) Patent Application Publication
(10) Pub. No.: US 2016/0090668 A1
(43) Pub. Date: Mar. 31, 2016

(54) Absorbent Product

(71) Applicant: Euan Davidson, Hereford and Worcester (GB)

(72) Inventor: Euan Davidson, Hereford and Worcester (GB)

(21) Appl. No.: 14/891,485

(22) PCT Filed: May 14, 2014
(86) PCT No.: PCT/GB2014/051477

§ 371 Date: Dec. 1, 2015

(30) Foreign Application Priority Data
May 16, 2013 (GB) 1308874.5
Jul. 16, 2013 (GB) 1312763.4

(51) Int. Cl. D02G 3/34; B01J 20/28; B08B 17/02; B08B 1/00; D02G 3/36; D02G 3/44

(52) U.S. Cl. CPC D02G 3/34; D02G 3/36; D02G 3/447; B08B 17/025; B08B 1/003; B01J 20/2805; B01J 20/28033; D10B 2401/021; D10B 2505/00

(57) ABSTRACT

An absorbent string comprising of a plurality of absorbent products. Each product has a tubular envelope. In use, the string is placed by the side of an appliance such as a freezer, whereby moisture from the appliance on the floor can pass through the envelope and be absorbed by the absorbent material.

Each product has opposite ends that are complementarily shaped and are abutting with ends of adjacent products to form the absorbent string. The products have an elongate chevron shape. Each product has a double skin bottom and a single, folded top skin. Moisture on the floor can pass through the outer skin by capillary action into the product through the bottom. The absorbent material extends into the head and tail ends and up to the sealed periphery.

The present invention relates to an absorbent product.

It is well known to contain absorbent material in a permeable enclosure to absorb moisture and allow it to be removed manually from the place where the water was collected by absorption. The absorbent material may be a so-called “super absorber”, which is able to absorb and retain larger amounts of water than ordinary cloths for instance.

A particular situation where absorbent products are deployed is in retail premises on the floor around chillers, refrigerators and deep freezes, all of which are prone to condensation forming outside and running onto the floor, which can be dangerous.

In Our Earlier Application, British Patent Application No. 1212660.3, we describe an absorbent product comprising:
absorbent material and
a permeable container of sheet material containing the absorbent material and having:
   a fold in the sheet material with an outer web of the material over-lying an inner web at the fold and
   an indicator on the inner web
      the arrangement being such that the outer web normally covers the indicator when the absorbent material has absorbed a determined amount of moisture, whereupon it swells, opening the fold and exposing the indicator.

It is also known to use absorbent products containing “super-absorber” materials to provide a barrier to a liquid spreading across a surface. An example of such a barrier is described in U.S. Pat. No. 8,034,184, where an elongate absorbent tape comprising sections of “super absorber” material within a fluid permeable cover is able to “swell” on absorption of liquid to form a barrier to a large flow of liquid. The sections of the tape are separable by tearing along transverse separating structures between the sections, whereby the super absorber material extends across the separating structures in order to minimize the flow of liquid between adjacent sections. At the separating structures, the super absorber is exposed and is not held within the fluid permeable cover.

The object of the present invention is to provide an improved absorbent product.

According to the invention there is provided an absorbent product, the product comprising a plurality of component lengths, each having absorbent material and having complementarily shaped opposite ends, which are shaped transversely to non-linear and/or oblique, the ends providing longitudinal overlap of the absorbent material from one length to the next when the lengths are placed end to end or are joined in a string of separable lengths.

Whilst it is envisaged that the formed ends of a product may be tapered to either side of the product, for longitudinal overlap of the absorbent material when abutted with another product, preferably each product has a single protrusion at one end and a complementary notch at the other end. Alternatively one end may have a plurality of protrusions and the other end a plurality of complementary notches. Where the formed ends have more than one protrusion and more than one complementary notch, the absorbent material of two abutted products will form interdigitated fingers of absorbent material across a transverse junction between the abutted products.

Preferably each product is shaped as an elongate chevron. Each elongate chevron has a first, formed end with a single, central overlap portion and a complementary, opposite formed end with two, outer overlap portions either side of a mouth. In use, the first end of a first product abuts the second end of a neighbouring product, whereby the central overlap portion of the first product occupies the mouth of the neighbouring product. The central overlap portion of the first product overlaps the outer overlap portions of the neighbouring product along the length of the string.

Preferably the absorbent product comprises:
absorbent material and
a permeable container of sheet material containing the absorbent material.

A border of sheet material may be provided at the formed ends of the products. Where a border of sheet material is provided at the formed ends, a channel devoid of absorbent material is formed at abutted ends of the products. Normally the border of sheet material is a seal securing the absorbent material within the container of sheet material at least at the formed ends.

An adhesive layer may be provided on a bottom surface of the product for securing the product in a use position. The adhesive layer may be provided in the centre of the product, or at the ends, but preferably it extends substantially the length of the product. The adhesive may be sprayed or painted directly onto the product or alternatively may be a double sided tape. Preferably the adhesive layer is adhered to a release paper for storage and transport of the product.

The bottom surface of the product may be at least partially coated with a hydrophobic substance. The hydrophobic substance is preferably provided at least at the formed ends of the product. The hydrophobic substance may be sprayed or painted directly onto the product.

Although it is envisaged that a product may be provided individually, preferably a group of products are provided in a string. A string of products may be comprised of a plurality of products abutted and joined end to end. Alternatively a string of products may be comprised of a plurality of aligned products, each product being independently attached to a backing tape. Where the products are provided in a string and are abutted and joined end to end, the joint preferably includes means for separating the products, typically comprising partially cut ends of the products. Where the products are not joined end to end and provided on a backing tape, the products may be abutted end to end or arranged such that a gap is formed between the products. Where an adhesive layer is provided, the adhesive layer may be the means for attaching the products to the backing tape, wherein the backing tape preferably acts as release paper for the products.

For storage, a string of products may be folded in a ziz-zag arrangement one on-top of the other or the string may be coiled into a roll.

In use, a string of products may be positioned on a surface to control the spread of a liquid over the surface. Where the products are provided on a backing tape, preferably the products are individually removable from the tape and positionable on the surface such that complementary ends of neighbouring products are abutted. On encountering a product in the string, a spreading liquid will be absorbed by the absorbent material. On encountering the complementary ends of a pair of abutted products in the string, the liquid will be channelled between the ends whereby it will encounter the longitudinally overlapping absorbent material and be absorbed.

To help understanding of the invention, a specific embodiment thereof will now be described by way of example and with reference to the accompanying drawings, in which:

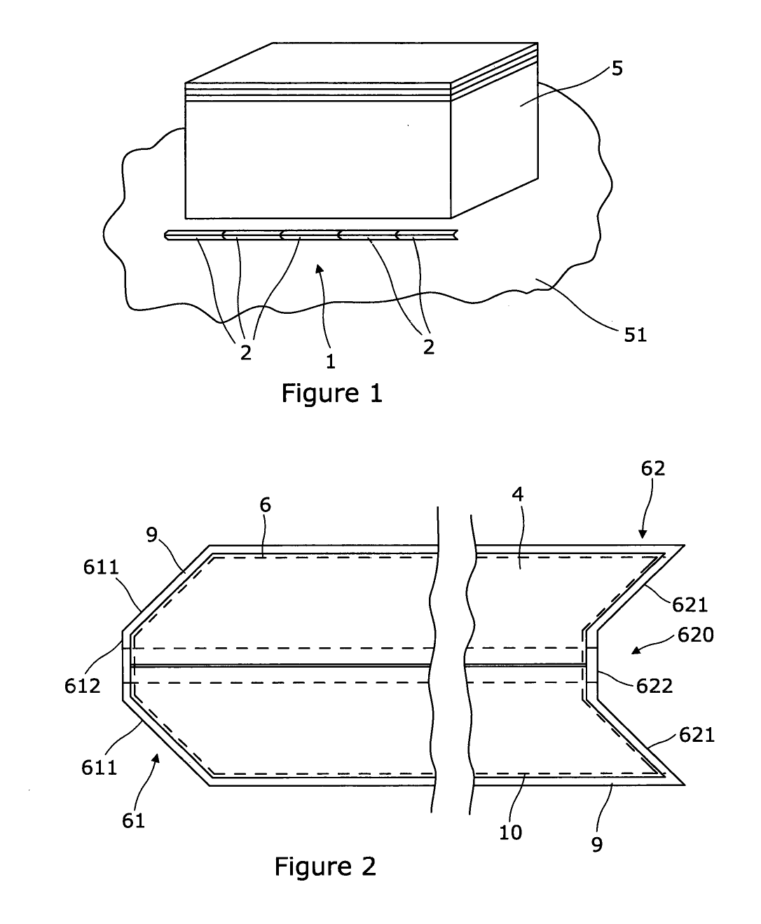

FIG. 1 is a perspective view of a freezer prone to condensation with absorbent products of the invention set out around it;

FIG. 2 is a plan view of a fresh one of the products of the absorbent product of the invention;

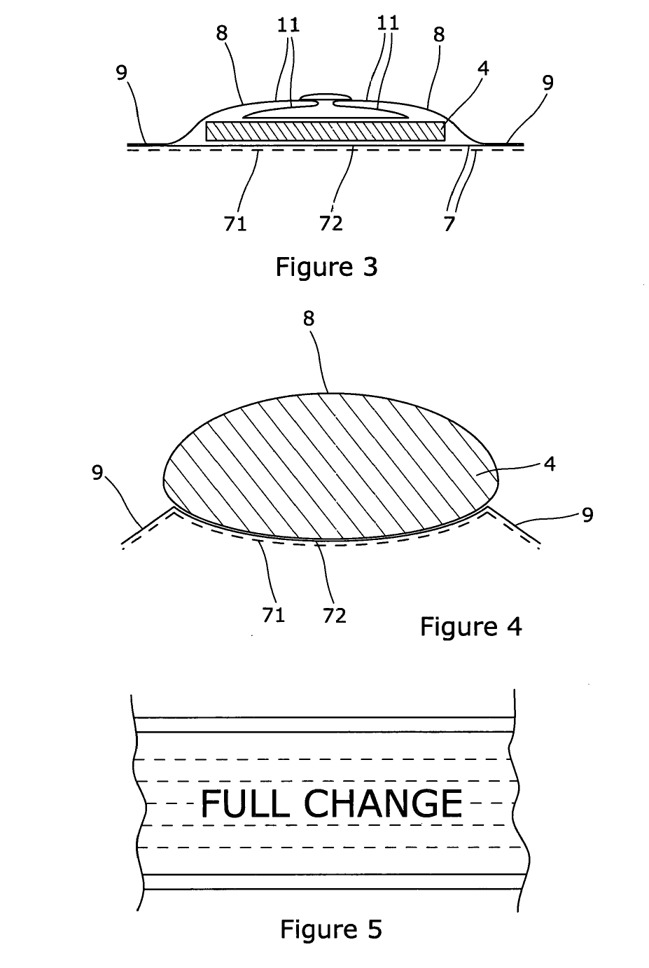

FIG. 3 is a cross-sectional end view of the product of FIG. 2;

FIG. 4 is a similar cross-sectional view of a product after absorbing its fill of moisture;

FIG. 5 is a plan view of a full product with its “FULL-CHANGE” indicator exposed;

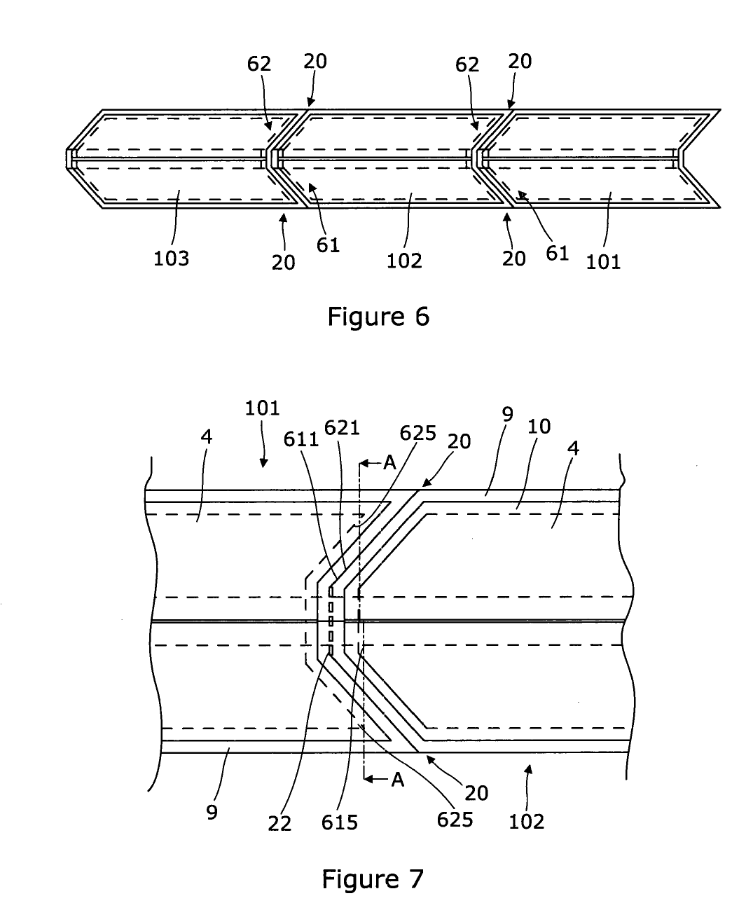

FIG. 6 is a plan view of a string of three fresh absorbent products of the invention;

FIG. 7 is a plan view of two adjacent products of the absorbent product of FIG. 6 in co-operation;

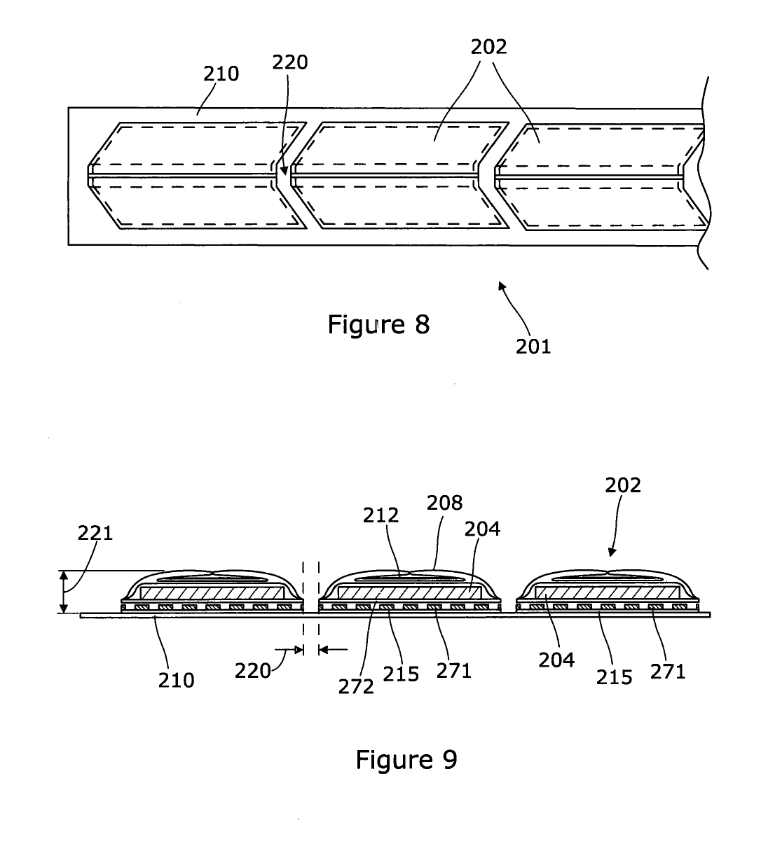

FIG. 8 is a plan view of an alternative string of products according to the invention;

FIG. 9 is a side cross-section of the string of products of FIG. 9 through the centreline of the string; and

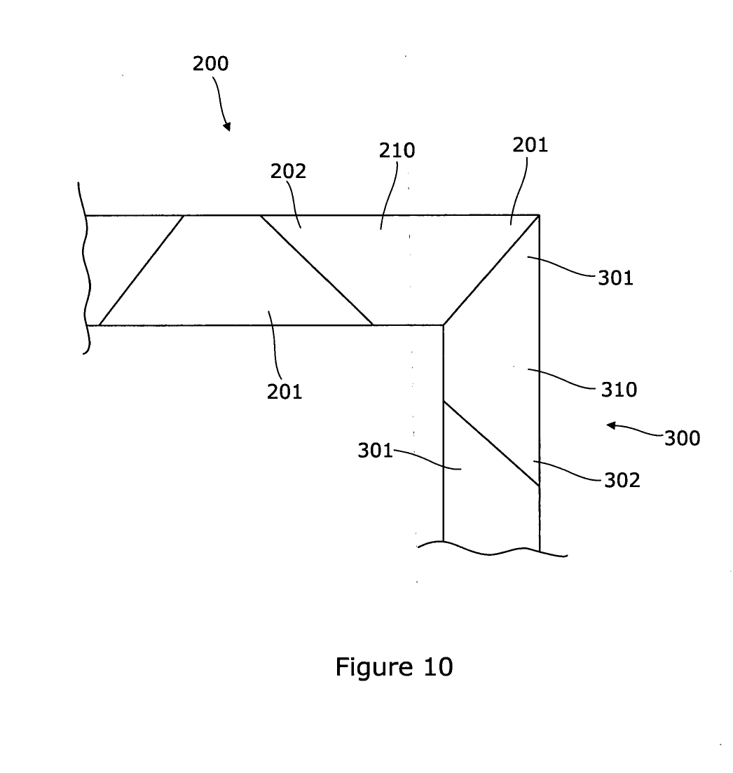

FIG. 10 is a plan view of an alternative string of products according to the invention.

Referring to the drawings, an absorbent string 1 is comprised of a plurality of absorbent products 2. Each product has a tubular envelope 3 which is generally flat in use and contains absorbent material 4. The latter will normally have super absorber in its composition. In use, the string 1 is placed by the side of an appliance such a freezer 5, whereby moisture from the appliance on the floor 51 can pass through the envelope 3 and be absorbed by the absorbent material 4.

In accordance with the invention, each product 2 has opposite ends 61, 62 that are complementarily shaped and are abutting with ends of adjacent products to form the absorbent string 1.

The products 2 have an elongate chevron shape. The head end 61 of each chevron product is trapezoidal, with outer, converging side edges 611 and a leading, central edge 612. The opposite, tail end 62 of the chevron product has two outer jaws either side of a mouth 620, within which the head end 61 can fit, the mouth having outer side edges 621 diverging from a central edge 622.

Each product has a double skin bottom 7 and a single, folded top skin 8 which is heat sealed around its periphery 9 to contain the absorbent material. The top skin is of porous non-woven material, through which moisture dripping onto it can pass for absorption by the absorbent material 4. The outer skin 71 of the bottom 7 is of perforate plastics material film and the inner skin 72 is of non-woven material as the top is. Moisture on the floor can pass through the outer skin by capillary action into the product through the bottom. When the container has absorbed its fill of moisture and there is a tendency for the absorbent material to ooze out, the outer skin assists in resisting this oozing.

The absorbent material 4 extends into the head and tail ends 61, 62 and up to the sealed periphery 9, although a small gap 10 is provided between the periphery and the absorbent material for the absorbent material to expand on absorption of liquid.

The non-woven sheet material of the top 8 of each product has an elongate, double Z fold 11 as described in Our Earlier Application. In use, as the absorbent material absorbs moisture from condensation running down the freezer onto the floor, it expands from a flat form to a round shape. The absorbent material causes tension in the skins of the container as it reaches its absorption limit, which tears the self-adhesive strips causing the folds to unfold and the round shape to slump. The inner webs are exposed and an indicator 12 in the form of the words “FULL-CHANGE” printed along the inner webs is provided to alert maintenance staff of the need to change a filled absorbent product for a fresh one.

Referring to FIG. 6 and FIG. 7, an absorbent string 100 comprises three products 101, 102, 103. The head end 61 of the first product 101 is complimentary to and abutting with the tail end 62 of the adjacent product 102. The outer edges 611, 612 of the head end of the first product 101 abut with outer edges 621, 622 of the tail end of the adjacent product 102 and the products 101, 102 are joined together along their central inner edges 612, 622 by a perforated cut 22. The joined products may be separated by tearing along the perforated cut 22.

At the junction between the products 101, 102, the sealed periphery 9 of the head and tail ends forms a channel 20 between the products which is devoid of absorbent material.

An axis A-A, extends centrally between the adjacent products 101, 102, at the junction between the products, transverse the length of the string. The channel 20 does not extend along the axis A-A, but rather follows the edges 611, 612, and 612, 622.

Overlap portions 615, 625 of respective head and tail ends 61, 62 of the products 101, 102, overlap the axis A-A longitudinally of the string 100. The overlap portions 615, 625 also contain the absorbent material 4 which also longitudinally overlaps the axis A-A.

In use, the string 100 is placed on a surface in the path of a spreading liquid. The spreading liquid, on meeting a product in the string, passes through the porous tubular material and is absorbed by the absorbent material 4. At the junctions between the strings, the liquid flows into the channels 20 which are devoid of absorbent material. To flow across the entire width of the string without encountering absorbent material, the liquid must first flow along the direction of one of the outer edges 611, 621, then along the direction of the central edges 612, 622 and finally along the direction of the other outer edges 612, 611. Thus the liquid flowing along the path of the channels is required to change direction at the corners of the outer and central edges to avoid the absorbent material. As such, the liquid does not have a direct, straight path along which it is able to cross the string without encountering the absorbent material.

The length of the channels 20 at the junctions is longer than that of conventional product string junctions, which have transverse channels extending along the transverse axis A-A. The increased length and the changes of direction of the channels increases the likelihood of absorption of the spreading liquid by the string at the junctions between the products.

As a variant, the bottom surface of the product can be treated by painting or spraying with a hydrophobic substance. In particular, where the treatment is in the channels 20 (which are devoid of absorbent material) liquid tending to flow in the channels 20 will be repelled by the hydrophobic substance and the flow will be inhibited.

The string of joined products may be folded together for storage and transport in a zig-zag formation, one product on-top of the other, by folding each product in alternate directions along the perforated cuts. Alternatively, strings of joined products may be wound into a roll for storage and unwound and divided for use.

Referring to FIG. 8 and FIG. 9, an alternative string 201 comprises three separate absorbent products 202. Each absorbent product comprises absorbent material 204 surrounded on all sides by a porous tubular envelope having a bottom skin 272 and an upper folded skin 208, concealing an indicator 212 below the folds. An outer bottom skin 271 of perforate plastics material is provided under the bottom skin 272 to resist oozing of absorbed liquid from the absorbent material. The outer bottom skin 271 is provided on its exposed outer surface with adhesive layer 215 for retaining the product in a use position on a surface.

For storage and transport, each product is disposed on an elongate sheet of release paper 210. The products are separately adhered to the paper by their adhesive layer 215. The adhesion between the paper and the adhesive is less than that between the bottom skin 271 and the adhesive such that the adhesive remains on the product when the product is peeled off the paper. The products are aligned end to end along the paper with a gap 220 left between the opposing ends of neighbouring products. Whilst on the backing paper the string of products may be coiled into a roll or stacked in a zig-zag formation, one on top of the other. For stacking, the gap 220 between the products should be greater than twice the thickness 221 of the products such that the paper may be folded and the products lie flat on top of one another without bending of the absorbent material.

For use, a product 202 may be individually peeled from the release paper and pressed into position on the surface on which the liquid is to be controlled. Where more than one product is required, a number of products may be peeled from the paper and positioned on the surface with complimentary ends abutted with neighbouring products as described above.

The invention is not intended to be restricted to the details of the above described embodiment. For instance, an absorbent string may comprise any number of products. A plurality of the elongate products may be manufactured in-line, as continuous a string, typically in a single process. The seal around the periphery of the envelope may extend only partially around the absorbent material, or alternatively the envelope may be a single sheet folded over the absorbent material and sealed along one edge only. The absorbent material may be contained inside a matted strip, housed within the envelope. A biocidal agent may be provided with the absorbent material to protect a surface against bacteria and other harmful substances.

The formed ends of the products may be shaped differently. For example, the ends may be pointed or may have a complimentary regular wave shape. A perforated cut may run along the entire length of the channels between the products. Alternatively, the products may not be joined together. The absorbent material may extend to the edges of the head and tail portions such that no channel is provided between two abutting products, rather a slit is formed between them. The products may be shaped such that as the absorbent material absorbs liquid, it swells and pushes out over the channels and may even close the channels by abutment with the adjacent product.

The ends of the products may be shaped such that the products may be abuttingly placed at corners between two strings. Referring to FIG. 10, a string 300 is comprised of products 301 having opposite ends 312, 313 tapered to one sides, at a 45° angle to the length of the products. Normally, the first end 312 of a product in the string is abutted with the second end 312 of the next product in the string, such that the string extends in a straight line. A 90° corner is formed in the string by abutting the first end 311 of a first product with the first end 311 of a second product.

1-13. (canceled)

14. An elongate absorbent product, the product comprising a plurality of component lengths, each having absorbent material and having at least one protrusion at one end and at least one complementary notch at the other end, which are shaped transversely to be non-linear and/or oblique, the ends providing longitudinal overlap of the absorbent material from one length to the next when the lengths are placed end to end or are joined in a string of separable lengths.

15. The elongate absorbent product according to claim 14, wherein the lengths are shaped as elongate chevrons, each chevron having a formed end with a single, central overlap portion and a complementary, opposite formed end with two, outer overlap portions either side of a mouth, whereby the central overlap portion of the absorbent material of one length occupies the mouth of the neighbouring absorbent material, the central overlap portions overlapping the outer overlap portions along the length of the string.

16. The elongate absorbent product according to claim 14, wherein each length comprises a permeable container of sheet material containing the absorbent material.

17. The elongate absorbent product according to claim 16, wherein a border of sheet material is provided at the formed ends of the lengths separating the absorbent material of the one length from that of the next.

18. The elongate absorbent product according to claim 17, wherein the border of sheet material secures the absorbent material within the container of sheet material at the formed ends.

19. The elongate absorbent product according to claim 14, wherein one side of the lengths is at least partially coated with a hydrophobic substance.

20. The elongate absorbent product according to claim 19, wherein the hydrophobic substance is provided at least at the ends of the lengths.

21. The elongate absorbent product according to claim 14, having an adhesive layer on a bottom surface of the product, the adhesive being provided centrally, at the ends or substantially along the length of the product.

22. The elongate absorbent product according to claim 21, wherein the adhesive is sprayed or painted directly onto the product or is a double sided tape.

23. The elongate absorbent product according to claim 21, wherein the adhesive layer has a release paper.

24. The elongate absorbent product according to claim 14, wherein the lengths are adjoined end to end by a non-linear and/or oblique joint, the joint preferably including means for separating the products, the joint more preferably comprising partially cut ends.

25. The elongate absorbent product according to claim 14, wherein the lengths are independently attached to a backing tape and the lengths are aligned end to end or arranged such that a gap is formed between them.

26. The elongate absorbent product according to claim 25, when an adhesive layer and release paper is provided, the adhesive layer is the means for attaching the lengths to the backing tape and the backing tape acts as release paper for the products.
